(19) United States
(12) Patent Application Publication
(10) Pub. No.: US 2022/0300454 A1
(43) Pub. Date: Sep. 22, 2022

(54) SYSTEMS AND METHODS OF CURATING DATA

(71) Applicant: Avaya Management L.P., Durham, NC (US)

(72) Inventors: Vivekananda Velamala, Brighton, CO (US); Prasanna Kulkarni, Pune (IN); Dileep Kumar Pandey, Sultanpur (IN); Saurabh Kumar Tyagi, Muzaffarnagar (IN)

(21) Appl. No.: 17/205,923

(22) Filed: Mar. 18, 2021

(51) Int. Cl. G06F 16/16; G06F 16/11

(52) U.S. Cl. CPC G06F 16/162; G06F 16/122

(57) ABSTRACT

Systems and methods described herein include automatically curating data within a computing system. Systems and methods involve performing with one or more processor: receiving an algorithm; identifying a storage system within the computing system; executing the algorithm within the storage system; in response to executing the algorithm within the storage system, identifying one or more files; and deleting the one or more identified files from the computing system.

### FIELD

The present disclosure relates generally to computer storage systems and more particularly to curating data within computer storage systems.

### BACKGROUND

Users of computing systems such as personal computers, tablets, smartphones, servers, etc., use several types of data sources to store and manage data. For example, a user may store PDF documents, Word documents, audio and video files, HTML, XML, and other filetypes as data. Data may be stored on local storage systems such as a hard drive or a solid-state drive. Data may be stored in cloud-computing storage systems.

Modern data storage systems provide the benefit of widely accessible data solutions. With the increasing accessibility of data storage, a problem arises with the ever-growing volume of data being stored. Data storage devices often become filled with unneeded data.

In particular, log management is increasingly an issue for data storage systems. Many computer applications and services record data logs at a high frequency resulting in large amounts of data being stored over time.

To overcome the problem of disks filled to capacity, data must be deleted. Many users resort to manual methods of selecting individual files or folders for removal.

Contemporary methods of automatically removing data from a data storage system often involve curating data within the system using a simple age policy. For example, a contemporary system may involve removing any data which is 14 days or older. Other contemporary methods of automatically removing data involve removing data based on a threshold disk usage, with older data being removed once disk usage reaches a certain threshold.

Conventional methods of data curation often occurs by monitoring and removing files based on file-based factors such as age of the data or external factors such as disk usage. Other conventional methods of removing data from storage systems involve machine learning or artificial intelligence (AI) systems on data to remove data based on recommendations and/or outputs of the machine learning or AI systems.

The use of age and disk space to automatically remove data by conventional systems are less-than-optimal and prone to inefficiency, as the data curation is essentially a blind application of data age and/or disk space to clean up data.

### BRIEF DESCRIPTION OF THE DRAWINGS

The detailed description below is described with reference to the accompanying figures. In the figures, the use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is a block diagram of an illustrative system for implementing data curation algorithms in accordance with one or more embodiments of the present disclosure;

FIG. 2 is a block diagram of a computer system configured to create and implement data curation algorithms in accordance with one or more embodiments of the present disclosure;

FIG. 3 is a flow diagram of a process for creating and implementing data curation algorithms in accordance with one or more embodiments of the present disclosure; and

FIGS. 4A and 4B are illustrations of user interfaces in accordance with one or more embodiments of the present disclosure.

### DETAILED DESCRIPTION

The above-described issues with conventional systems for establishing and implementing data curation algorithms for networks may be resolved using systems and methods as described herein. What is needed is an autonomous method of creating a set of data curation algorithms which can be used in any scenario, regardless of variations in node population, network topology, and firewall vendors. These and other needs are addressed by the various embodiments and configurations of the present disclosure.

The following presents a simplified summary of one or more embodiments in order to provide a basic understanding of the one or more embodiments and is intended to neither identify key elements of the embodiments nor delineate the scope of such embodiments. Its sole purpose is to present some concepts of the described embodiments in a simplified form as a prelude to the more detailed description presented below.

According to one or more embodiments of the present disclosure, a method for curating data within a storage system may comprise a user device configured to execute one or more of an algorithm management, algorithm creation, algorithm implementation, or other type of application capable of managing and implementing a data curation system as described herein. Such a device may be designed to actively curate data within one or more computer-based storage systems as described herein.

The phrases “at least one,” “one or more,” “or”, and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate,” and “compute,” and variations thereof, as used herein, are used interchangeably, and include any type of methodology, process, mathematical operation, or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

As described herein, a data curation method or system may involve an algorithm-based curation framework which accepts algorithms with a pre-defined syntax. Algorithms can in some embodiments be used in conjunction with other algorithms. Algorithms may consider not only the nature or attributes of data to be curated, but also the underlying environment. For example, an algorithm may be implemented in a cluster computing environment to delete any data irrespective of age if the data belongs to a service which is no longer installed in the cluster. A cluster may be considered a conglomeration of services which work together to provide a user experience. Any services running on a cluster may be managed by a same management entity.

Data curation as described herein may comprise a method or system implemented across one or more servers or network devices. A cluster may comprise a plurality of servers connected via local connection or across a wide area network such as the Internet.

Services may include, for example, a speech-analysis service, audio conferencing service, or any other type of service as should be appreciated.

Using systems and methods as described herein, an environment-aware data curation system may be established. Data curation algorithms may be established to curate data based on factors such as a name of a service, a size of a service, or other recognizable qualities. Using runtime based decisions, data may be curated based on any number of factors and qualities.

Data curation may be performed to curate data such as logs of data, data files, metadata associated with files, or any type of digital data.

As described above, log management is increasingly an issue for data storage systems. The systems and methods described herein provide a solution to ever-increasing amounts of data such as data logs, including files and lines of data. When an application or a service is executed within a system, the application or service may create runtime information relating to how the system is behaving. This runtime information may be stored as a series of logs. Logs may be in the form of a file comprising a plurality of lines of data. In some embodiments, a single file may comprise a plurality of lines of data associated with or created by a plurality of services or applications.

While the systems and methods described herein may be used to curate or prune data logs, it should be appreciated the same or similar systems and methods may apply to curating or pruning any type of data.

Contemporary solutions for curating data involve timed or pre-scheduled algorithms designed to select and remove data. The presently describe methods and systems provide algorithms capable of being dependent on a computing environment and capable of being detected while running in the environment. The systems and methods described herein provide for the curating or pruning of logs based on the service that created the logs or other identifying characteristics, rather than simply a timing of creation of the logs. Systems and methods as described herein may provide for the curating of data based on certain conditions, such as a size of a service having created the data. For example, a service with a relatively small footprint as compared to other services may be allowed a lesser number of logs stored in memory as compared to the relatively larger services. Using such an algorithm, the system executing the data curation method may be enabled to determine a size of any services installed within a cluster, identify any data, e.g., logs, metadata, etc., which relates to each service, determine a size of storage occupied by the data relating to each service, determine whether any data should be deleted for each service, and determine what data should be deleted for each service. For example, data for each service which exceeds its allotted memory storage may be curated based on additional factors such as date of creation, etc.

As a second example, a data curation algorithm may be enabled such that any data associated with any service which has been uninstalled for ten days may be deleted. Using such an algorithm, the system executing the data curation method may be enabled to determine which services have been uninstalled, determine how long each service has been uninstalled, and identify any data, e.g., logs, metadata, etc., which relates to those services.

As a third example, a data curation algorithm may be enabled such that any data associated with a particular past user who is no longer an active user of a computer device within a cluster may be deleted. For example, business entities may use an algorithm to delete any data for any user who is no longer an employee of the business entity. Using such an algorithm, the system executing the data curation method may be enabled to determine which users are no longer active, identify any data, e.g., logs, metadata, etc., which relates to those users, and delete the identified data.

As a fourth example, a data curation algorithm may be enabled such that any data of a particular age associated with a first service may be deleted upon detection of data a particular age associated with a second service being deleted. For example, one application may comprise ten different services. A data curation algorithm may be enabled such that if one service is removed, the other nine services should also be removed. Similarly, a data curation algorithm may be enabled such that if the application is removed, all services associated with the application may be removed. Using such an algorithm, the system executing the data curation method may be enabled to determine which services are associated with a particular application, determine whether any service has been uninstalled, and identify any data, e.g., logs, metadata, etc., which relates to each service.

Data curation algorithms as described herein may be used as system-wide configuration tools which may be configured as needed by users such as system administrators to curate data within a cluster or within a single computing device. Algorithms may be executed in an immediate manner by a user upon command, may be scheduled to occur on a particular frequency or time interval, or may be performed automatically based on detection of a triggering event.

As described herein, logic may be applied in a runtime environment to detect and locate data to be curated based on one or more rules or algorithms during the execution of a service or application.

High level rules may be enabled which may be interpreted at runtime based on runtime information. For example, if an application is removed from a cluster, all the logs associated with the application may be removed after inactivity of, for example, ten days. For a data curation algorithm to perform such curation, the algorithm must be capable of identifying the application has been removed, determining what services were associated with the application, determining what data is associated with the services, determine how long the data associated with the services has been inactive, and perform removal of the data.

While the description of the systems and methods provided herein refers generally to pruning, curating, and deleting data, it should be appreciated that the same or similar methods and systems may apply to moving data between storage systems, or otherwise modifying the storage of data. For example, a data moving algorithm may be enabled such that any time a user interacts with a file, the file may be copied to a second location as a backup. As should be appreciated, algorithms may be established to rename, copy, and move data automatically.

The methods and systems described herein resolve the above-mentioned problems with conventional systems by utilizing pre-defined algorithms that sort, remove, and/or organize data without applying a blind data cleanup.

Systems and methods described herein may be capable of detecting an environment associated with data. For example, the system may detect that a file contains a large amount of data related to a service that has been uninstalled for four days. In conventional systems, data may continue to exist within the system for another ten days, until the fourteen-day timeframe arrives, at which point the data would be deleted.

Such conventional methods cause systems to carry unnecessary data, which may be harmful to the operation of the system. With the systems and methods described herein, the system would be able to identify that the service has been uninstalled and may remove the data associated with that service from the system. This allows the system to maintain a more active data curation service, which reduces the amount of unnecessary data maintained by the system.

Using algorithm-based curation, various algorithms may be combined or implemented in a series or together to more efficiently and effectively curate data. Algorithms may be created which aware of the nature and/or attributes of data, where such nature or attributes can be actively used to curate the data.

Algorithms may be created which are aware of the environment and the state of the environment where the algorithms are implemented. In some embodiments, the state of the environment can be used as a criterion for data curation. For example, an algorithm may be created to delete any data for an uninstalled service based on for how long the service has been uninstalled.

The systems and methods described herein provide advantages over contemporary methods by reducing the time and effort required to maintain an active data curation of a system. The systems and methods described herein prevent data storage systems from maintaining unnecessary or burdensome data files.

While conventional systems take only age or disk space into account, the systems and methods described herein utilize additional intrinsic values of the data as well as an environment of the data.

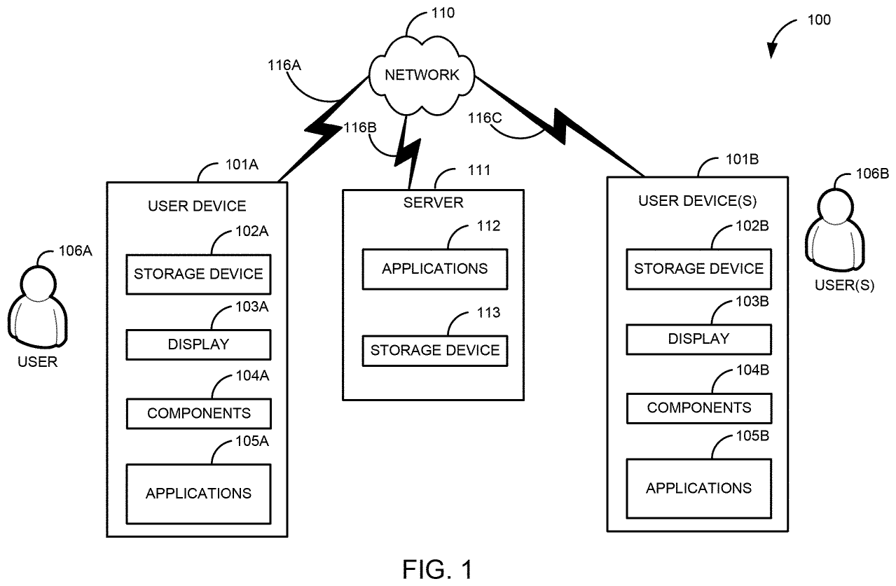

A data curation system may be implemented, for example, in a computing environment 100 as illustrated in FIG. 1. FIG. 1 is a block diagram of a first illustrative computing environment 100 which may be used in conjunction with a data curation system in accordance with one or more of the embodiments described herein. The illustrative computing environment 100 comprises user devices 101A, 101B and a network 110. In addition, user devices 106A-106B are also shown.

The user devices 101A, 101B can be or may include any user device that can communicate on the network 110, such as a Personal Computer (“PC”), a laptop, a video phone, a video conferencing system, a cellular telephone, a Personal Digital Assistant (“PDA”), a tablet device, a notebook device, a smartphone, and/or the like. It should be appreciated that any number of user devices 101 may be connected to the network 110.

The user devices 101A, 101B may further comprise storage devices 102A, 102B, displays 103A, 103B, and/or other components 104A, 104B. Also, while not shown for convenience, the user devices 101A, 101B typically comprise other elements, such as a microprocessor.

In addition, the user devices 101A, 101B may also comprise application(s) 105A, 105B. The application(s) 105A can be any application, such as, a slide presentation application, a document editor application, a document display application, a graphical editing application, a calculator, an email application, a spreadsheet, a multimedia application, a gaming application, and/or the like. The storage devices 102A, 102B can be or may include any hardware device capable of storing data.

The displays 103A, 103B can be or may include any hardware display or projection system that can display an image of a video conference, such as a LED display, a plasma display, a projector, a liquid crystal display, a cathode ray tube, and/or the like. The displays 103A-103B can be used to display user interfaces.

The user devices 101A, 101B may also comprise one or more applications 105A, 105B. The applications 105A, 105B may work with storage devices 102A, 102B.

The network 110 can be or may include any collection of communication equipment that can send and receive electronic communications, such as the Internet, a Wide Area Network (WAN), a Local Area Network (LAN), a Voice over IP Network (VoIP), the Public Switched Telephone Network (PSTN), a packet switched network, a circuit switched network, a cellular network, a combination of these, and the like. The network 110 can use a variety of electronic protocols, such as Ethernet, Internet Protocol (IP), Session Initiation Protocol (SIP), H.323, video protocol, video protocols, Integrated Services Digital Network (ISDN), and the like. Thus, the network 110 is an electronic communication network configured to carry messages via packets and/or circuit switched communications.

The network may be used by the user devices 101A, 101B, and a server 111 to carry out systems and methods as described herein. During the performance of the systems and methods described herein, data 116A may be sent and/or received via user device 101A, data 116B may be sent and/or received via server 111, and data 116C may be sent and/or received via user device 101B.

The server 111 may comprise any type of computer device that can communicate on the network 110, such as a server, a Personal Computer (“PC”), a video phone, a video conferencing system, a cellular telephone, a Personal Digital Assistant (“PDA”), a tablet device, a notebook device, a smartphone, and/or the like. Although only one server 111 is shown for convenience in FIG. 1, any number of servers 111 may be connected to the network 110.

The server 111 may host one or more applications 112 and storage device(s) 113 and, while not shown for convenience, may comprise elements such as a microprocessor, a microphone, a browser application, and/or the like.

Data curation algorithms may be created, implemented, and managed using a computing device such as a personal computer, smartphone, or other device. For example, and as described herein, a user such as an administrator for a network may use a software application to create algorithms. Using the same or a different software application, as described herein, a user may implement created algorithms within a network or a computer device such as a server. The user may also select a runtime or frequency of executing each algorithm and a destination or network location within which each algorithm should be implemented.

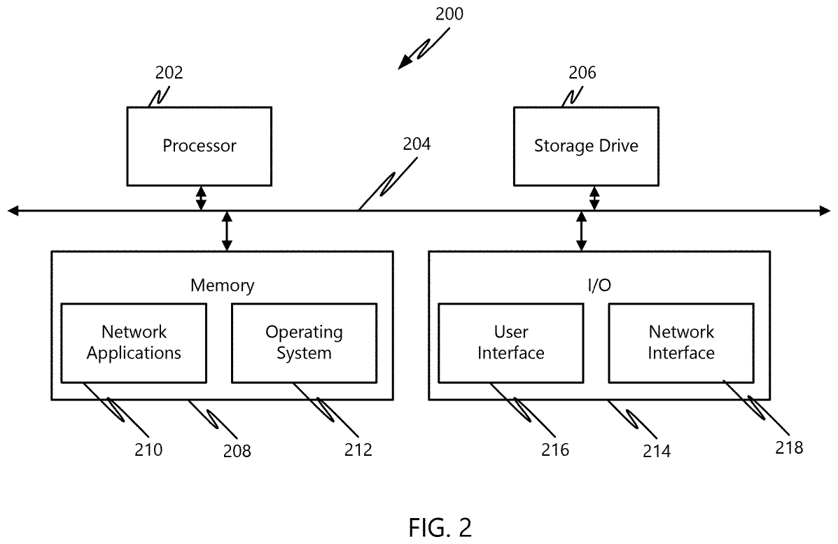

As illustrated in FIG. 2, a computer system 200 may be used to create and implement algorithms which may be executed in a computing environment 100 as illustrated in FIG. 1. The computer system 200 in some embodiments may comprise a processor and memory. The memory may store a number of software applications which may be configured to execute systems and methods as described herein to create and implement algorithms.

FIG. 2 is a block diagram of a computer system 200 capable of being configured to autonomously curate data within one or more computer-based storage systems. The computer system 200 may be configured to perform as a controller as described herein. The computer system 200 may be implemented in the environment 100 of FIG. 1 and may operate as controller 140. The computer system 200 may be a personal computing device, a laptop device, a mobile computing device, a server blade, an Internet appliance, a virtual computing device, a distributed computing device, a cloud-based computing device, or any appropriate processor-driven device.

The computer system 200 may comprise one or more processors 202 connected to a bus 204. The computer system 200 may comprise a storage device 206, memory 208 storing one or more network applications 210 and an operating system 212, and one or more input/output ports comprising a user interface and network interface. The network applications 210 may comprise one or more of a web browser, a mobile application, a networking application, an application configured to deploy one or more VMs, or the like.

Examples of the processor as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM 1926EJ-S™ processors, other industry-equivalent processors, and may perform computational functions using any known or future-developed standard, instruction set, libraries, and/or architecture.

A processor of a controller as described herein may be capable of obtaining certain aspects of data from a packet or flow of packets. Such data may include a destination of the packet and a source of the packet. The data obtained from packets or flows of packets may be a fairly abstract representation of the flow of data through a network. In practice, a network may comprise a number of VMs or computer systems grouped behind multiple firewalls and may be made up of a number of subnetworks.

In this way, a computer system 200 may be configured to curate data on devices in communication with the system 200 over a wide-area networks (WANs) such as the Internet, one or more local area networks (LANs) and/or one or more subnetworks, e.g., networks of computing devices within a LAN or across a WAN.

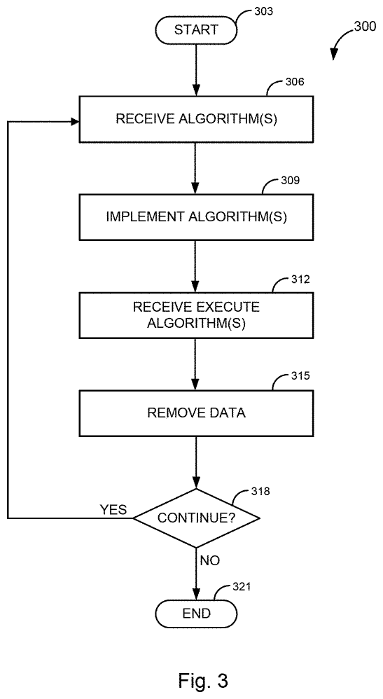

In some embodiments, a computer system may be configured to execute a data curation method 300 as described herein in relation to the flowchart of FIG. 3. The method 300 may begin at step 303. The computer system executing the method may be a system 200 as described herein in relation to FIG. 2 and may be in a computing environment 100 as described herein in relation to FIG. 1.

The computing environment may include one or more data storage systems such as hard drives, solid-state drives, and the like. In some embodiments, the data curation method may be performed to curate data stored on multiple storage systems across multiple devices across a network. In some embodiments, the data curation method may be performed by a computer system to curate data stored on a single drive within the computer system. It should be appreciated that the systems and methods described herein may be applied to a plurality of situations to curate data in one or more storage systems.

One or more steps of the method 300 and other methods described herein may be executed in full or in part by a user such as a system administrator. The user may be in control of a computer system or in a user device in communication with a computer system. It should be appreciated that one or more steps of the method 300 may alternatively be performed by a computer system automatically without user interference.

One or more of the steps of the method 300 may be executed by one or more processors and/or microprocessors of the computer system. The method 300 may involve storing data in a data storage system in communication with the computer system as part of certain steps of the m method 300.

The method 300 may begin with an algorithms creation system such as an application executing on the computer system. It should be appreciated that executing an algorithms creation system may comprise a user opening an application on a user device such as a smartphone or personal computer. In some embodiments, the algorithms creation system may be executed by a processor of a computer system in order to curate data within the same computer system while in other embodiments, the algorithms creation system may be executed by a processor of a computer system in order to curate data within one or more other computer systems.

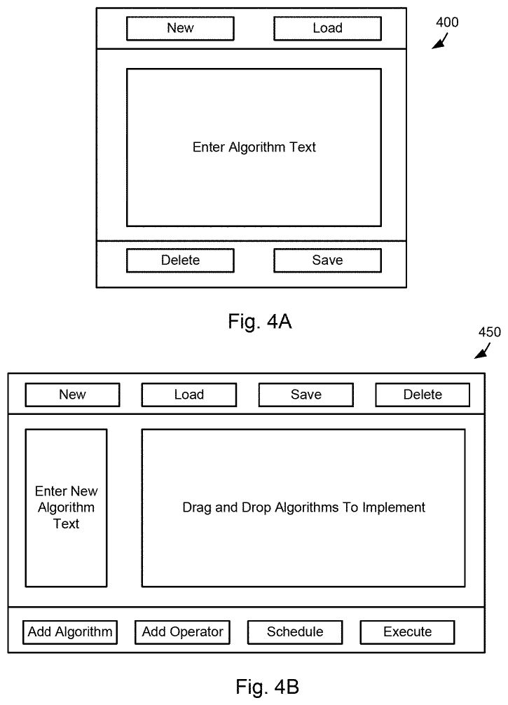

In some embodiments, the algorithms creation system may comprise a display of a user interface such as that illustrated in FIG. 4A on a display device in communication with the computer system executing the method 300.

As illustrated in FIG. 4A, a user interface of an algorithms creation system may comprise one or more graphical user interface (“GUI”) buttons which may be interacted with by one or more users of the computer system executing the algorithms creation system. Such GUI buttons may comprise, for example,

An algorithm creation system may be executed by a computing device 200 as illustrated in FIG. 2. One or more algorithms may be created via an algorithm creation system using a computing device 200. Creating an algorithm may comprise a user interacting with an algorithm creation system executing on the computing device 200. The algorithm creation system may comprise a user interface 400 such as that illustrated in FIG. 4A. Created algorithms may be stored in memory in communication with the computing device 200.

An algorithm creation system may be interacted with by a user via a user interface 400 as illustrated in FIG. 4A. As illustrated in FIG. 4A, a user interface 400 of an algorithm creation system may comprise a GUI text box to enable a user to type text for a new algorithm.

The user interface 400 of the algorithm creation system may comprise a GUI button to enable a user to save the text stored in the text box as a new algorithm or to replace an existing algorithm.

The user interface 400 of the algorithm creation system may comprise a GUI button enabling a user to load an existing algorithm. Once loaded, text of the existing algorithm may be displayed in the GUI text box and may be edited by the user. An edited existing algorithm may be saved to replace the existing algorithm or may be saved as a new algorithm.

The user interface 400 of the algorithm creation system may comprise a GUI button enabling a user to delete an existing algorithm. For example, a user may select an algorithm saved in memory and delete the algorithm from the memory.

At step 306, the processor of the computer system may receive one or more algorithms. Receiving an algorithm may comprise, for example, a new algorithm being created by a user using an algorithms creation system or an existing algorithm being selected using a computer application such as an algorithms management system as described herein.

The creation of algorithms may comprise, for example, the entry of text by a user of a computer system interacting with a user interface as illustrated in FIG. 4A. A user may enter text of an algorithm in a text box and may save the algorithm as a new algorithm. The user may select an algorithm for example by clicking a “load algorithm” GUI button. Below is a number of example algorithms which may be created and/or used to curate data in accordance with one or more of the embodiments described herein. It should be appreciated that any number of types of algorithms may be created in a similar way.

The following algorithm is an example of an algorithm which may be created to delete any data which is logged as a DEGUB and/or a TRACE message:

{
“name”: “trace-cleanup”,
“matchRegex”: “\hat{ }DEBUG.*|\hat{ }TRACE.*”,
“action”: “DELETE”
}

The following algorithm is an example of an algorithm which may be created to delete any data based on regex irrespective of age:

{
“name”: “SLA-cleanup””,
“matchRegex”: “\hat{ }someMethod Duration.*”,
“action”: “web-hook”
“url”: “http://es:7900/my-index-000001/delete_by_query”
}

The following algorithm is an example of an algorithm which may be created to delete data for GDPR compliance:

{
“name”: “PersonalData-cleanup”
“matchRegex“: “CustomerName: .*|CustomerPhone:.*”,
“action”: “web-hook”
“url”: “http://es:7900/my-index-000001/delete_by_query”
}

The following algorithm is an example of an algorithm which may be created to delete lines with length greater than 2000 characters:

{
“name”: “length-cleanup”
“matchLength”: “>2000”,
“action”: “DELETE”
}

In some embodiments, algorithms may be created which are aware of service association and dependencies. For example, an algorithm may be implemented to delete logs associated with a first service if and when logs associated with a second service have been removed. For example, the following algorithm may be created to delete lines of data associated with inactive services:

{
“name”: “inactive-service-cleanup”,
“data.source”: “!alive”,
“action”: “DELETE”
}

In some embodiments, an algorithm may be created to delete files by association. As an example, the following algorithm is an example of an algorithm which may be created to delete Fluentd logs if elastic search logs are deleted:

{
“name”: “fluentd-deletionBy-ES”,
“data.source.dependentOn”: “ElasticSearch”,
“data.target”: “Fluentd”
“action”: “DELETE”
}

At 309, one or more algorithms may be implemented. Implementing an algorithm may comprise selecting an algorithm or combination of algorithms for immediate execution or may comprise scheduling an algorithm or combination of algorithms for execution at a later time.

In some embodiments, an algorithm implementation system or algorithm management system may be executed by a computing device 200 as illustrated in FIG. 2. An algorithm management system may be interacted with by a user via a user interface 450 as illustrated in FIG. 4B.

Interacting with the user interface 450 of the algorithm management system illustrated in FIG. 4B, a user may be enabled to load one or more algorithms from memory using a GUI button. The user may be enabled to select from a number of logical operators, e.g., AND, OR, IF, THEN, NOT, etc. using a GUI button.

Using the user interface 450, a user may be enabled to implement algorithms in combination using logic. For example, algorithms may be combined using an AND operator. Using the user interface 450, a user may be enabled to drag and drop algorithms and logical operators to create a combination of algorithms.

For example, a combination such as Algorithm A AND Algorithm B OR Algorithm C may be written as follows: {([AlgorithmA] [AND] [AlgorithmB]) [OR] [AlgorithmC]}. It should be appreciated that any combination of algorithms may be created in this way.

Combined algorithms may be saved using a GUI button as a new algorithm combination.

Combined algorithms may be implemented as part of a data curation system. In this way, combined algorithms may be combined with other algorithms or combined algorithms to create more complex algorithms.

For example, a first algorithm may be selected which may be configured to curate data relating to a particular service and a second algorithm may be selected to execute at a particular time or frequency. Combining the algorithms may curate the data relating to the particular service at the particular time or frequency.

It should be appreciated that the algorithm creation system and the algorithm management system may be parts of a single software program or may be separate software programs.

Algorithm may be implemented using logic such as AND and/or OR statements. In this way, algorithms can be combined to create intelligent systems to actively curate data in an efficient manner. For example, the example algorithms above could be run in with an OR operator or with an AND operator. For example, with an AND operator, algorithms may be established to delete DEBUG messages with a line length of greater than 2,000 characters. With an OR operator, the same or similar algorithms may be established to delete any DEBUG messages or any messages with a line length of greater than 2,000 characters.

Utilizing AND and/or OR operators to combine algorithms can allow for unique combinations of data curation. These unique combinations allow the system to more efficiently and effectively curate data than more traditional age-only curation techniques.

At 312, the one or more implemented algorithms may be executed. Algorithms implemented, for example using an algorithm management system, may be executed automatically by a processor of a computer system 200. For example, algorithms may be implemented and executed at a scheduled time, at a particular frequency, at regular intervals, immediately, or upon a detection of a triggering event.

At 315, data may be removed from one or more storage systems based on the implemented algorithm or algorithms. For example, an algorithm may identify one or more files or lines of data from one or more storage systems within a device or across a network. The identified files or lines may be, based on the algorithm or algorithms, automatically deleted from the storage systems.

In some embodiments, data may be automatically backed up prior to deletion. For example, an algorithm may specify a particular file location which data to be deleted should be saved prior to being deleted from the original location of the data.

At 318, a decision may be made as to whether the process 300 should continue. If the process 300 should continue at 318, the process 300 may comprise returning to 306 at which point one or more algorithms may be received as discussed above. At 321, the process 300 may end.

It should be appreciated that data as discussed herein may be stored simultaneously in any number of storage devices or may be transmitted between storage devices at any time. No data as discussed herein should be considered as being limited to data stored within any single storage device.

Embodiments of the present disclosure include a method of automatically curating data within a computing system, the method comprising performing with one or more processors: receiving an algorithm; identifying a storage system within the computing system; executing the algorithm within the storage system; in response to executing the algorithm within the storage system, identifying one or more files; and deleting the one or more identified files from the computing system.

Aspects of the above method include wherein the algorithm is a combination of two or more algorithms.

Aspects of the above method include wherein receiving the algorithm comprises receiving a selection of two or more algorithms and a selection of one or more logical operators.

Aspects of the above method include wherein a first algorithm of the two or more algorithms identifies a minimum line length.

Aspects of the above method include wherein a first algorithm of the two or more algorithms identifies an uninstalled service.

Aspects of the above method include wherein executing the algorithm comprises the one or more processors determining an amount of time elapsed since the service was uninstalled.

Aspects of the above method include wherein identifying one or more files comprises identifying files associated with the service.

Embodiments of the present disclosure include a user device comprising: a processor; and a computer-readable storage medium storing computer-readable instructions which, when executed by the processor, cause the processor to: receive an algorithm; identify a storage system within the computing system; execute the algorithm within the storage system; in response to executing the algorithm within the storage system, identify one or more files; and delete the one or more identified files from the computing system.

Aspects of the above user device include wherein the algorithm is a combination of two or more algorithms.

Aspects of the above user device include wherein receiving the algorithm comprises receiving a selection of two or more algorithms and a selection of one or more logical operators.

Aspects of the above user device include wherein a first algorithm of the two or more algorithms identifies a minimum line length.

Aspects of the above user device include wherein a first algorithm of the two or more algorithms identifies an uninstalled service.

Aspects of the above user device include wherein executing the algorithm comprises the one or more processors determining an amount of time elapsed since the service was uninstalled.

Aspects of the above user device include wherein identifying one or more files comprises identifying files associated with the service.

Embodiments of the present disclosure include a computer program product comprising: a non-transitory computer-readable storage medium having computer-readable program code embodied therewith, the computer-readable program code configured, when executed by a processor, to: receive an algorithm; identify a storage system within the computing system; execute the algorithm within the storage system; in response to executing the algorithm within the storage system, identify one or more files; and delete the one or more identified files from the computing system.

Aspects of the above computer program product include wherein the algorithm is a combination of two or more algorithms.

Aspects of the above computer program product include wherein receiving the algorithm comprises receiving a selection of two or more algorithms and a selection of one or more logical operators.

Aspects of the above computer program product include wherein a first algorithm of the two or more algorithms identifies a minimum line length.

Aspects of the above computer program product include wherein a first algorithm of the two or more algorithms identifies an uninstalled service.

Aspects of the above computer program product include wherein executing the algorithm comprises the one or more processors determining an amount of time elapsed since the service was uninstalled.

To avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub-combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments , configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A method of automatically curating data within a computing system, the method comprising performing with one or more processors:
receiving an algorithm;
identifying a storage system within the computing system;
executing the algorithm within the storage system;
in response to executing the algorithm within the storage system, identifying one or more files; and
deleting the one or more identified files from the computing system.

2. The method of claim 1, wherein the algorithm is a combination of two or more algorithms.

3. The method of claim 2, wherein receiving the algorithm comprises receiving a selection of two or more algorithms and a selection of one or more logical operators.

4. The method of claim 3, wherein a first algorithm of the two or more algorithms identifies a minimum line length.

5. The method of claim 3, wherein a first algorithm of the two or more algorithms identifies an uninstalled service.

6. The method of claim 5, wherein executing the algorithm comprises the one or more processors determining an amount of time elapsed since the service was uninstalled.

7. The method of claim 6, wherein identifying one or more files comprises identifying files associated with the service.

8. A user device comprising:
a processor; and
a computer-readable storage medium storing computer-readable instructions which, when executed by the processor, cause the processor to:
receive an algorithm;
identify a storage system within the computing system;
execute the algorithm within the storage system;
in response to executing the algorithm within the storage system, identify one or more files; and
delete the one or more identified files from the computing system.

9. The user device of claim 8, wherein the algorithm is a combination of two or more algorithms.

10. The user device of claim 9, wherein receiving the algorithm comprises receiving a selection of two or more algorithms and a selection of one or more logical operators.

11. The user device of claim 10, wherein a first algorithm of the two or more algorithms identifies a minimum line length.

12. The user device of claim 10, wherein a first algorithm of the two or more algorithms identifies an uninstalled service.

13. The user device of claim 12, wherein executing the algorithm comprises the one or more processors determining an amount of time elapsed since the service was uninstalled.

14. The user device of claim 13, wherein identifying one or more files comprises identifying files associated with the service.

15. A computer program product comprising:
a non-transitory computer-readable storage medium having computer-readable program code embodied therewith, the computer-readable program code configured, when executed by a processor, to:
receive an algorithm;
identify a storage system within the computing system;
execute the algorithm within the storage system;
in response to executing the algorithm within the storage system, identify one or more files; and
delete the one or more identified files from the computing system.

16. The computer program product of claim 15, wherein the algorithm is a combination of two or more algorithms.

17. The computer program product of claim 16, wherein receiving the algorithm comprises receiving a selection of two or more algorithms and a selection of one or more logical operators.

18. The computer program product of claim 17, wherein a first algorithm of the two or more algorithms identifies a minimum line length.

19. The computer program product of claim 17, wherein a first algorithm of the two or more algorithms identifies an uninstalled service.

20. The computer program product of claim 19, wherein executing the algorithm comprises the one or more processors determining an amount of time elapsed since the service was uninstalled.
